(19) United States
(12) Patent Application Publication
(10) Pub. No.: US 2007/0238008 A1
(43) Pub. Date: Oct. 11, 2007

(54) Aerogel-based vehicle thermal management systems and methods

(76) Inventors: Edward John Hogan, Hudson, MA (US); Mark Thaddeus Krajewski, West Newton, MA (US); Poongunran Muthukumaran, Worcester, MA (US)

Correspondence Address: ASPEN AEROGELS INC.;IP DEPARTMENT, 30 FORBES ROAD, BLDG. B, NORTHBOROUGH, MA, 01532, US

(21) Appl. No.: 11/211,881

(22) Filed: Aug. 24, 2005

Related U.S. Application Data
(60) Provisional application No. 60/603,929, filed on Aug. 24, 2004.

(51) Int. Cl. H01M 4/00

(52) U.S. Cl. 429/44

(57) ABSTRACT

Aerogel-based thermal management systems and methods for vehicles incorporate aerogel materials to provide insulation and heat shielding. Various components of a vehicle must be protected from high temperatures, and conventional insulation undesirably adds weight and mass to the vehicle. Aerogel materials can be used for heat insulation and heat shielding while consuming minimal space and weight in the vehicle. The aerogel materials can be provided in monolithic or fiber-reinforced composite form, and can be enclosed in an encapsulating material such as a polymer, elastomer, or metal. The aerogel material is then attached on or near an automobile component.

### CROSS-REFERENCE TO RELATED APPLICATION

This application claims the benefit of U.S. Provisional Application Ser. No. 60/603,929 filed on Aug. 24, 2004, the teachings of which are incorporated herein by reference.

### FIELD OF INVENTION

The present invention relates to thermal management systems and methods for vehicles such as automobiles and the like, and more particularly to aerogel-based thermal management systems and methods utilizing aerogels for insulation and heat shielding.

### BACKGROUND OF THE INVENTION

Consumer demand for spacious, quiet, and comfortable cabins, and engines that deliver more power in automobiles and light trucks often can conflict with engineering needs to reduce vehicle size and weight to comply with government emissions and mileage standards. As such, there is limited space available to manage the thermal and acoustical loads of a vehicle, while providing a suitable level of comfort for drivers and passengers. In some localized areas of the vehicle, use of conventional heat management solutions can result in temperatures that approach or exceed acceptable limits, which can lead to increased warranty expenses.

As light vehicle manufacturers strive to increase the power and acceleration of vehicles, without significantly increasing the size of the engine or drive train, engine temperatures have continued to climb, thereby increasing the demand for under-hood heat shielding and thermal management. On some platforms, heat given-off by the engine is now in the range of 200-225° C., which is near or beyond the limit of existing materials to provide effective heat shielding or insulation for under-hood components. Temperatures at this level, and even significantly below, can have an adverse impact on the operating performance and life of components such as batteries, starters, electronic engine management controls, sensors, and climatic system components.

Heat sensitive automobile components are provided in various regions of the vehicle that are subjected to high temperatures. Due to space constraints, these components cannot be relocated to lower temperature regions of the vehicle. There is an unresolved need for a thermal management system capable of managing the heat load and temperature exposure of such heat sensitive components. Conventionally, little or no insulation has been provided around many automobile components.

One example of a conventional thermal management system used to manage heat loads of certain automobile components is a stainless steel plate provided on or near one or more components. Although stainless steel plates can partially shield automobile components from a sudden heat load, they are not capable of protecting the components from accumulated heat load, especially when the vehicle is driven for an extended period of time. Stainless steel plates, like other metal protectors, are not true insulators, and thus offer limited protection against steady heat loads. Other conventional insulators suffer from one or more of the following drawbacks: excessive size, low insulation value or high conductivity, and high temperature instability.

Other conventional types of insulation, such as glass-filled foams, fibers, and metals can tolerate high temperatures, but have a relatively low capacity for shielding and insulation. For such materials, in order to provide effective thermal management, the thickness of the insulation must be increased. Since there may be little or no available space to accommodate the additional heat shielding and insulation, a different type of insulation system, material, and method to provide effective heat shielding and insulation is needed.

Aerogel materials are known to possess about two to six times the thermal resistance of other common types of insulation, e.g., foams, fiberglass, etc., and thus are ideally suited for use in thermal management systems. Aerogels can increase effective shielding and thermal insulation without substantially increasing the thickness of the insulation or adding additional weight. Aerogels are known to be a class of structures having low density, open cell structures, large surface areas, and nanometer scale pore sizes.

Aerogels have been disclosed in sprayable formulations for use in conjunction with certain automotive components. U.S. Patent Application Publication US 2003/0215640 to Ackerman et al. discloses a heat resistant aerogel insulation composite made up of: (1) an insulation layer consisting of hydrophobic aerogel particles, an aqueous binder, and optionally a foaming agent; and (2) a thermally reflective top layer. According to Ackerman et al., the aerogel insulation composite preferably is applied as a sprayable formulation for use in motor vehicle components such as the engine compartment, firewall, fuel tank, steering column, oil pan, trunk, spare tire, and for insulating the underbody of a vehicle, e.g., as a shield for components near the exhaust system.

European Publications 1,207,081 and 1,431,126 disclose aerogel particles in granular form that are combined with an adhesive binder and sprayed on surfaces of an automotive component such as the steering column, engine compartment, gear wall, floor, or exhaust line. PCT Publication WO 99/19169 discloses a foam matrix optionally including an aerogel as one possible component, where the foam matrix is used to provide insulation around a car battery. According to the above-described references, aerogel materials are provided in a foam matrix and/or sprayable form.

U.S. Pat. No. 5,550,338 to Hielscher discloses a thermal shield which can be used to cover a vehicle floor. In one embodiment, a thermal insulating layer can incorporate aerogels in the form of hard foam, flakes, powder, or granules.

It would be desirable to provide suitable insulation or heat shielding for automotive components in which aerogels are used in conjunction with areas of a vehicle that generate heat that may affect neighboring components, to minimize heat loss in certain areas, and to protect automotive components from harmful thermal radiation, where the insulation or heat shielding includes aerogels provided either as monoliths or as fiber-reinforced composites.

### SUMMARY OF THE INVENTION

Thermal management systems and methods of the present invention allow for cost-effective and efficient thermal management of vehicles using aerogel-based materials. Thermal management systems, including but not limited to insulation systems and heat shielding systems, of the present invention apply to automobiles and other vehicles utilizing internal combustion engines, fuel cell powered systems, electric power, electric and gas hybrid systems, and any other systems which include heat generating and/or heat sensitive components.

According to the systems and methods of the present invention, insulating performance is improved by using aerogel materials, instead of conventional materials such as glass-filled foams, fibers, and metals, where space and weight can be conserved by using such aerogel materials. In addition, the present invention can help reduce the expense of warranty repairs associated with premature failure of vehicle components due to excessive thermal loads.

The present invention is useful in conjunction with several components of a vehicle, including but not limited to: batteries, starter, alternator, air intake, headliner, convertible top, steering column, electronics package, firewall, windshield, catalytic converter, carpet underlayment, muffler, exhaust pipe, exhaust manifold, expansion valve, climatic components, drink holder, windows, roof, fuel tank, door, spark plugs, and other components.

According to the present invention, aerogel materials can be provided in any suitable form, such as granular, powder, and bead form, preferably as monoliths or fiber-reinforced composites. The chemical compositions of aerogel materials includes inorganic, organic, hybrid organic-inorganic compositions, or any combination thereof. Any combination of the above-mentioned forms and/or compositions can be used in conjunction with additives including but not limited to opacifying compounds and binders.

According to the present invention, aerogel materials can be encapsulated in a suitable encapsulating material and incorporated into insulation or a heat shield attached or adjacent to an automobile component. The encapsulated aerogel materials preferably include fiber-reinforced composite aerogel materials, but can also include monoliths provided in granular, powder, and/or bead forms. Optionally, the aerogel materials can be coated with one or more materials such as a polymer, elastomer, or metal.

A thermal management system according to the present invention can include at least one component of a vehicle, and an aerogel material enclosed in an encapsulating material, the aerogel material and encapsulating material provided on or near the at least one component.

A thermal management system according to the present invention can include at least one component of a vehicle, and an aerogel material in fiber-reinforced composite form, the aerogel material provided on or near the at least one component.

A method for insulating at least one component of a vehicle can include steps of: providing the at least one component, providing an aerogel material in fiber-reinforced composite form, and attaching the aerogel material on or near the at least one component.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1A is a perspective view of a vehicle including various components and systems incorporating the aerogel-based vehicle thermal management systems and methods of the present invention;

FIG. 1B is a cross-sectional side view of the vehicle shown in FIG. 1A;

FIG. 1C is a bottom perspective view of the vehicle shown in FIG. 1A;

FIG. 2 is a partial top perspective view of a vehicle depicting various components and systems under the hood of the vehicle;

FIG. 3 is a bottom perspective view of a vehicle depicting various undercarriage components and systems;

FIGS. 4A to 4D are perspective views of the steering column of a vehicle;

FIG. 5A is an exploded parts view of a floor structure of a vehicle;

FIG. 5B is an exploded cutaway view of a material insulation system of the floor structure shown in FIG. 5A;

FIG. 6A is a perspective view of a vehicle having a convertible top incorporating an aerogel material insulation system;

FIG. 6B is an exploded cutaway view of the convertible top incorporating the aerogel material insulation system shown in FIG. 6A;

FIG. 7A is a bottom perspective view of a vehicle depicting a starter;

FIG. 7B is an isolated perspective view of the starter shown in FIG. 7A incorporating a multi-layer aerogel material insulation system;

FIG. 7C is a cross-sectional end view of the starter shown in FIG. 7B;

FIG. 8 is an isolated perspective view of an air intake tunnel incorporating a multi-layer aerogel material insulation system;

FIG. 9 is an isolated perspective view of an expansion valve incorporating a multi-layer aerogel material insulation system;

FIG. 10A is a perspective view of a battery installed with an aerogel material insulation system under the hood of a vehicle;

FIGS. 10B and 10C are exploded views of the installation procedure of the aerogel material insulation system on the battery shown in FIG. 10A;

FIG. 11A is a bottom perspective view of a vehicle depicting a catalytic converter;

FIGS. 11B and 11C are isolated perspective and cross-sectional end views, respectively, of the catalytic converter shown in FIG. 11A with an aerogel material heat shield;

FIG. 12A is a bottom perspective view of a vehicle depicting an exhaust pipe;

FIGS. 12B and 12C are exploded perspective and cross-sectional end views, respectively, of the exhaust pipe shown in FIG. 12A with a multi-layer aerogel material heat shield;

FIG. 13A is a bottom perspective view of a vehicle depicting a muffler; and

FIGS. 13B and 13C are exploded perspective and cross-sectional end views, respectively, of the muffler shown in FIG. 13A with an aerogel material heat shield.

### DEFINITIONS

The instant invention is most clearly understood with reference to the following definitions:

As used in the specification and claims, the singular form “a”, “an” and “the” include plural references unless the context clearly dictates otherwise.

As used herein, the terms “aerogel” and “aerogel material” describe a class of structures having a low density, open cell structures, large surface areas, and nanometer scale pore sizes. Aerogel materials can be provided at least in powder, granular, bead, and other suitable forms, and include inorganic, organic, and hybrid organic-inorganic compositions, or some combination of the above forms and/or compositions.

As used herein, the term “automobile” includes any motor vehicle including light and heavy vehicles such as a car, truck, sports utility vehicle (SUV), van, bus, snowmobile, all terrain vehicle (ATV), scooter, motorcycle, tractor, construction vehicle, military vehicle, and the like, with or without a gas engine.

As used herein, the term “vehicle” includes any devices of conveyance, including automobiles, locomotives, boats, ships, airplanes, and rockets.

As used herein, the term “engine compartment” can be that of any vehicle.

### DETAILED DESCRIPTION OF THE INVENTION

Aerogel-based thermal management systems and methods are disclosed in the present invention. These thermal management systems include various insulation systems and heat shielding systems, which apply to automobiles and other vehicles utilizing internal combustion engines, fuel cell powered systems, electric power, electric and gas hybrid systems, and any other systems which include heat generating and/or heat sensitive components.

The aerogel-based thermal management systems and methods of the present invention can be used with various vehicle components, including but not limited to: batteries, starter, alternator, air intake, headliner, convertible top, steering column, electronics package, firewall, windshield, catalytic converter, carpet underlayment, muffler, exhaust pipe, exhaust manifold, expansion valve, climatic components, drink holder, windows, roof, fuel tank, door, spark plugs, and other components.

According to the present invention, aerogels can be provided in any suitable form, such as granular, powder, and bead form, preferably as monoliths or fiber-reinforced composites. A variety of different aerogel compositions can be used, including inorganic, organic, and hybrid organic-inorganic compositions. Inorganic aerogels are generally based upon metal oxide compounds including, but not limited to: silica, titania, zirconia, alumina, hafnia, yttria, or based on various carbides, nitrides or any combination of the preceding. Organic aerogels can be based on compounds including, but not limited to: urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, a member of the polyether family of materials or combinations thereof. Examples of organic-inorganic hybrid aerogels include, but are not limited to: silica-PMMA, silica-chitosan or a combination of the aforementioned organic and inorganic compounds.

Fiber-reinforced aerogel composites, also known as blankets, can take on a variety of forms. The fibrous material in fiber-reinforced aerogel composites of the present invention can be in the form of batting (fibrous or lofty), fibrous mats, felts, microfibers, or any combination thereof. A detailed discussion of such fiber-reinforced composites and methods of preparing the same can be found in U.S. Patent Application Publication US 2002/0094426, the entire contents of which are incorporated by reference herein. A further detailed discussion of fiber-reinforced composites can be found in U.S. Ser. No. 11/134,029, the entire contents of which are incorporated by reference herein.

Additionally, fiber-reinforced forms of organic, inorganic, and hybrid organic-inorganic aerogels can also be prepared. International Publication WO 2005/068361, incorporated by reference herein, describes fiber-reinforced hybrid organic-inorganic aerogel composites that are also highly flexible.

Additionally, a whole host of fibrous materials can be used in conjunction with aerogel materials as a reinforcing structure. A non-limiting list includes: polyester-based fibers including polyesters, polyolefin terephthalates, poly(ethylene) naphthalate, polycarbonates and rayon, nylon, cotton based LYCRA (manufactured by DuPont), carbon-based fibers like graphite, precursors for carbon fibers like polyacrylonitrile(PAN), oxidized PAN, uncarbonized heat treated PAN such as the one manufactured by SGL carbon, fiberglass-based material like S-glass, 901 glass, 902 glass, 475 glass, E-glass, silica-based fibers like quartz, QUARTZEL (manufactured by Saint-Gobain), Q-FELT (manufactured by Johns Manville), SAFFIL (manufactured by Saffil), DURABLANKET (manufactured by Unifrax) and other silica fibers, polyaramid fibers like KEVALR, NOMEX, SONTERA (all manufactured by DuPont) CONEXT (manufactured by Taijin), polyolefins like TYVEK (manufactured by DuPont), DYNEEMA (manufactured by DSM), SPECTRA (manufactured by Honeywell), other polypropylene fibers like TYPAR, XAVAN (both manufactured by DuPont), fluoropolymers like PTFE with trade names as TEFLON (manufactured by DuPont), GORE-TEX (manufactured by GORE), silicon carbide fibers like NICALON (manufactured by COI Ceramics), ceramic fibers like NEXTEL (manufactured by 3M), acrylic polymers, fibers of wool, silk, hemp, leather, suede, PBO-ZYLON fibers (manufactured by Tyobo), liquid crystal material like VECTAN (manufactured by Hoechst), CAMBRELLE fiber (manufactured by DuPont), polyurethanes, polyamaides, wood fibers, boron, aluminum, iron, stainless steel fibers and other thermoplastics like PEEK, PES, PEI, PEK, PPS and all other hydrid material polymeric or otherwise can be used as a material in preparing aerogel composites. The form or shape of such material can be batting, nonwoven, woven, felt, knit, braided, bengaline, boucle, and other architectural forms.

Methods of drying gels for generating aerogels or xerogels are well known. For example, Kistler (J. Phys. Chem., 36, 1932, 52-64) describes a drying process where the gel solvent is maintained above its critical pressure and temperature. Due to the absence of any capillary forces, such supercritical drying maintains the structural integrity of the gel. U.S. Pat. No. 4,610,863 describes a process where the gel solvent is exchanged with liquid carbon dioxide and subsequently dried at conditions where carbon dioxide is in a supercritical state. Such conditions are milder than the one described by Kistler. U.S. Pat. No. 6,670,402 teaches drying via rapid solvent exchange of solvent inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby resorcinol/formaldehyde aerogels can be manufactured using a simple air drying procedure. U.S. Pat. No. 5,565,142 describes a process where the gel surface is modified such that it is more hydrophobic and stronger so that it can resist any collapse of the structure during ambient or subcritical drying. Surface modified gels are dried at ambient pressures or at pressures below the critical point (subcritical drying). Products obtained from such ambient pressure or subcritical drying are often referred to as xerogels.

Opacification of aerogel materials can result in higher insulating performance of such materials. Compounds useful for opacifying aerogels include, but are not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

The thermal management systems and methods of the present invention incorporate aerogels provided at various locations and in conjunction with different components of a vehicle. Such systems incorporate aerogels in insulation systems and heat shielding systems to achieve improved thermal management performance and efficiency. Optionally, temperatures can be monitored at several locations around the automotive components and systems to evaluate thermal performance.

In accordance with the present invention, aerogel materials can be provided in granular form, powder form, bead form, or any other suitable form, including but not limited to an aerogel film. The aerogel materials can be monoliths or fiber-reinforced composites.

The aerogel materials can be enclosed or encapsulated to enhance durability and to provide ease of handling and installation. Encapsulating materials include aluminum, metal foils, and protective layers made up of one or more polymeric films or metallized polymeric films. The aerogel materials can be encapsulated either as a loose fitting pillow or as a tight lamination. The encapsulating material preferably is flexible for ease of handling and installation, but can be rigid.

The aerogel materials can be provided in a flexible or drapable form. Optionally, the aerogel materials can be coated with one or more materials such as a polymer, elastomer, or metal. High temperature glass fabrics or thin flexible metal panels also can be affixed to the aerogel materials. Through one or more of the above methods and arrangements, the aerogel materials can be more easily installed on or around the component that requires shielding, or for example, between the engine and the component.

The aerogel materials as described in embodiments of the present invention exhibit thermal conductivity values of less than about 25 mW/m*K (milliwatts per meter Kelvin), preferably less than about 20 mW/m*K, and more preferably less than about 15 mW/m*K, at atmospheric pressures and room temperatures.

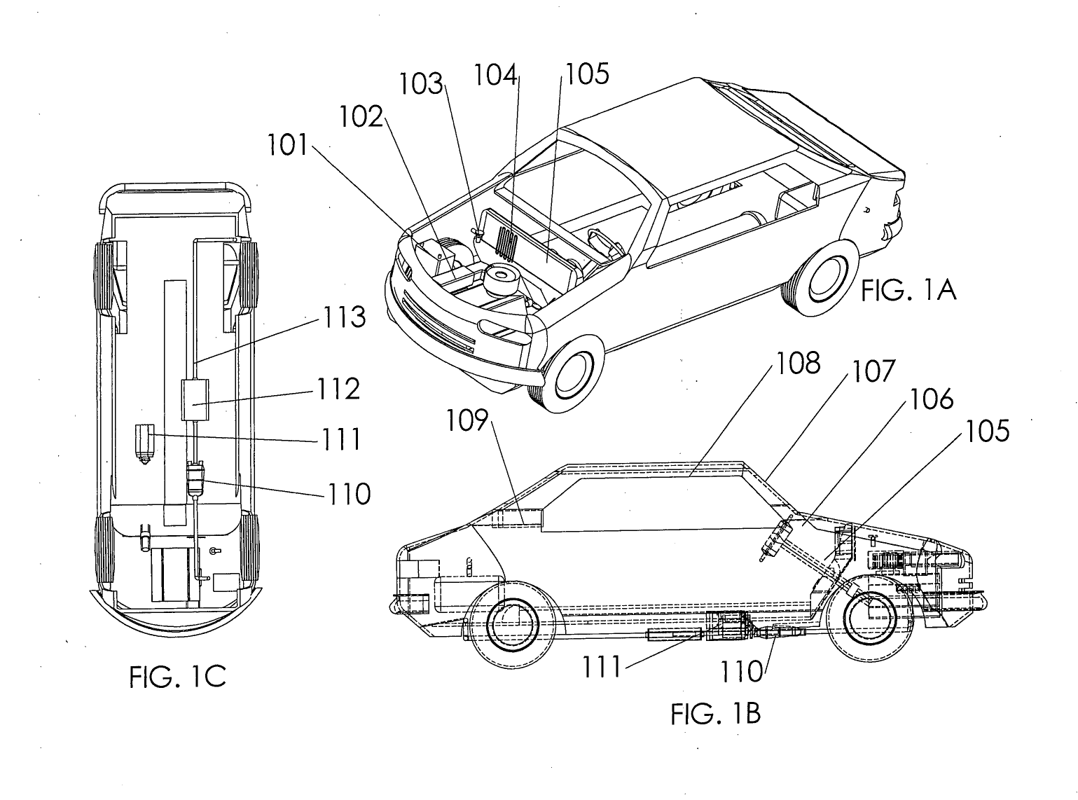

FIGS. 1A to 1C are different views of a vehicle depicting a plurality of vehicle components that include thermal management systems, where aerogel materials can be incorporated into these thermal management systems to provide improved thermal efficiency and performance.

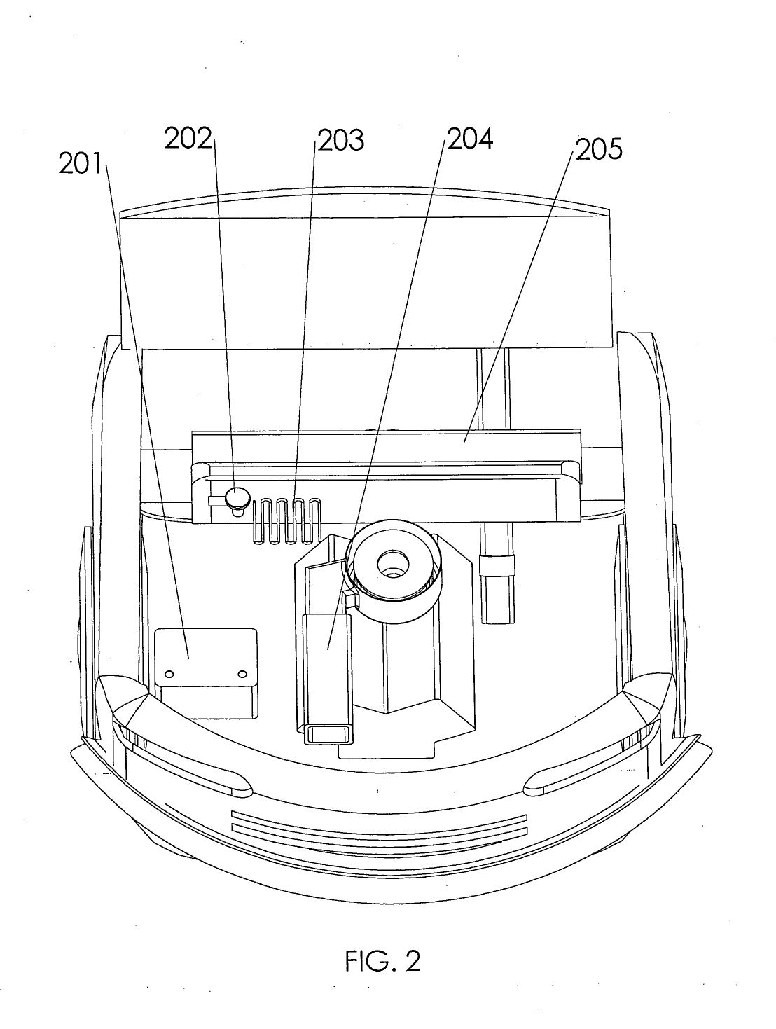

FIG. 2 is a view under the hood of the vehicle depicting the engine compartment and related components. It is known that higher engine loads can raise the temperature of intake air for combustion, resulting in lower engine efficiency and a decrease in horsepower. According to one embodiment of the present invention, an aerogel material can be wrapped around an intake tunnel 204 (see also intake tunnel 102 in FIG. 1A), or installed in the air filter box. Typically, there is little room available for insulation around these components. However, because aerogel materials have a high thermal capacity and require only minimal space for installation, aerogel materials can suitably be installed around the intake tunnel 204, air filter box, and other engine components.

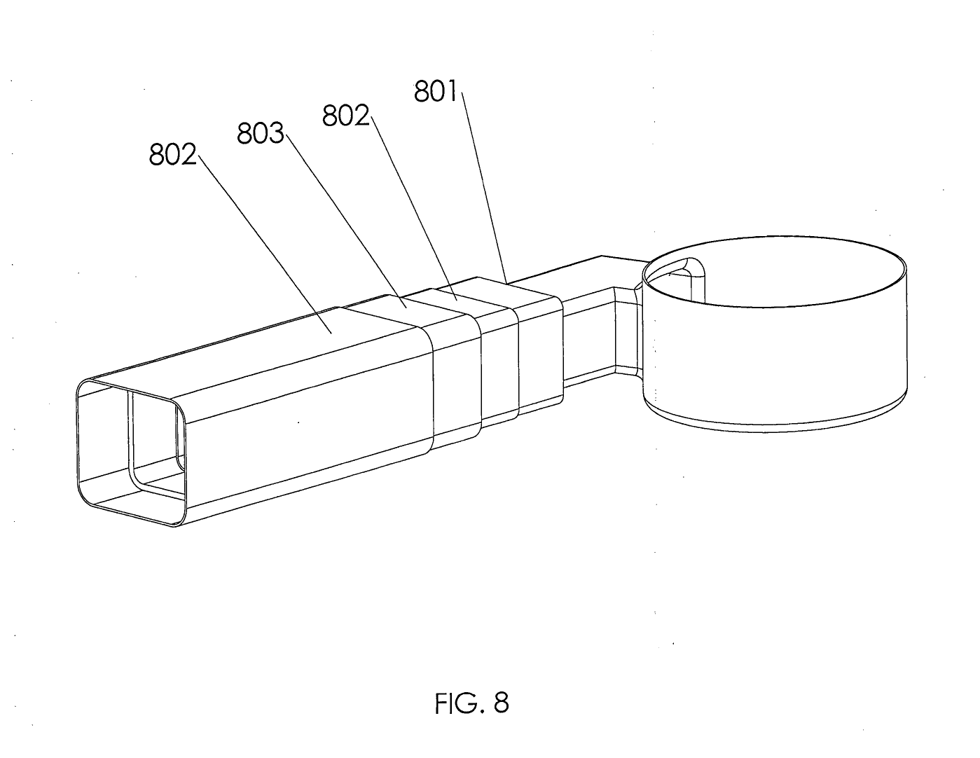

FIG. 8 provides a more detailed view of an air intake tunnel 801, which is similar to the air intake tunnel 204 depicted in FIG. 2. As shown in FIG. 8, a fiber-reinforced aerogel composite 803 is encapsulated in foil 802, and then wrapped around the air intake tunnel 801. The encapsulation can include one or more upper and lower layers of the foil 802. This assembly can be secured to the air intake tunnel by using mating VELCRO strips on the leading edges of the assembly; alternatively, metal or plastic bands can be used to secure the assembly. As a further alternative, a high temperature pressure sensitive adhesive and release liner can be affixed to the sides, top, and bottom of the air filter box while aligning a hole in the top piece with an air entry port (not shown).

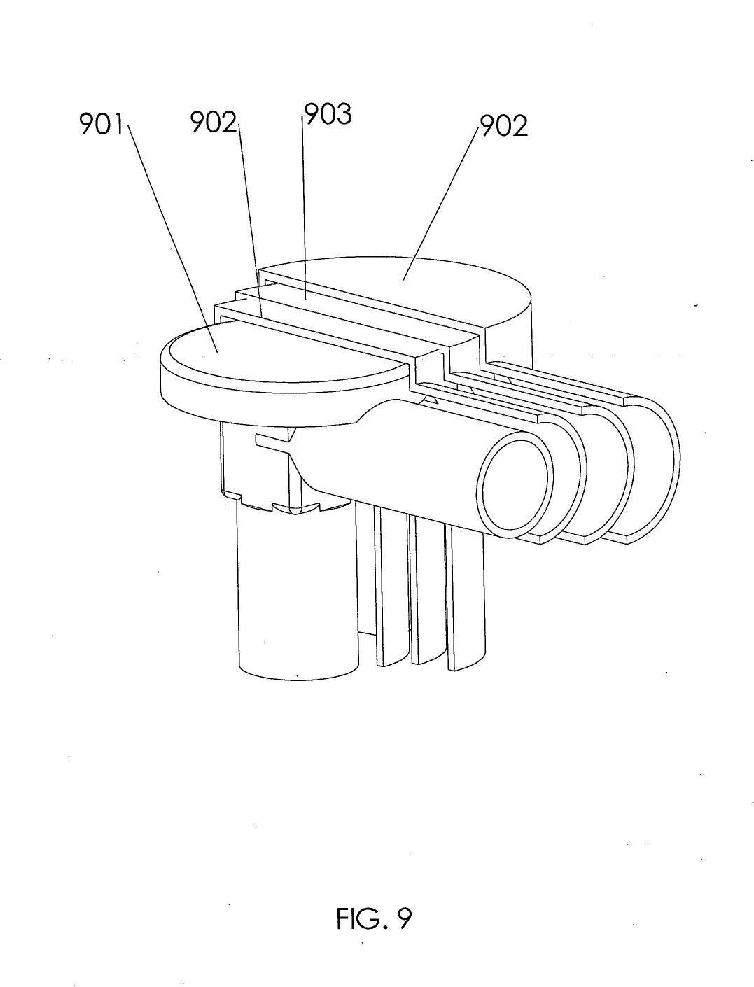

Foil-encapsulated aerogel materials also can be wrapped around small, heat-sensitive components such as air conditioner expansion wells and valves. As shown in FIG. 2, an expansion valve 202 is located adjacent to an evaporator 203 on or near the vehicle's firewall 205. Also, referring to FIG. 1A, an expansion valve 103 is located near an evaporator 104 on the firewall 105. A more detailed view of the expansion valve insulated by aerogel materials is shown in FIG. 9.

Referring to FIG. 9, one or more suitable materials are used to encapsulate an aerogel material 903. The expansion valve 901 shown in FIG. 9 is insulated by the aerogel material 903 encapsulated by a foil 902 and/or another suitable material such as high-temperature films or coated fabrics. In particular, the aerogel material 903 can be encapsulated in one or more upper and lower layers of the foil 902.

Another form of encapsulated aerogels is aerogel materials that are encapsulated in high-temperature glass fabrics or elastomers, such as silicone, and then sized and shaped for use with components such as spark plug boots. Since spark plugs are inserted directly into the engine block, the spark plug body must be insulated or shielded to protect it from engine temperatures to assure the unimpeded delivery of electric charge to the spark plug tip. Typically this is accomplished through a thick rubber sleeve or boot, but as engine temperatures have climbed, additional insulation or shielding is needed to ensure the long-term operation and efficient performance of spark plugs. A variety of arrangements are possible, including placing a thin aerogel material layer into the boot as it is being molded, or wrapping a glass or foil encapsulated aerogel material around existing boots and securing the encapsulated aerogel materials with a plastic or metal band.

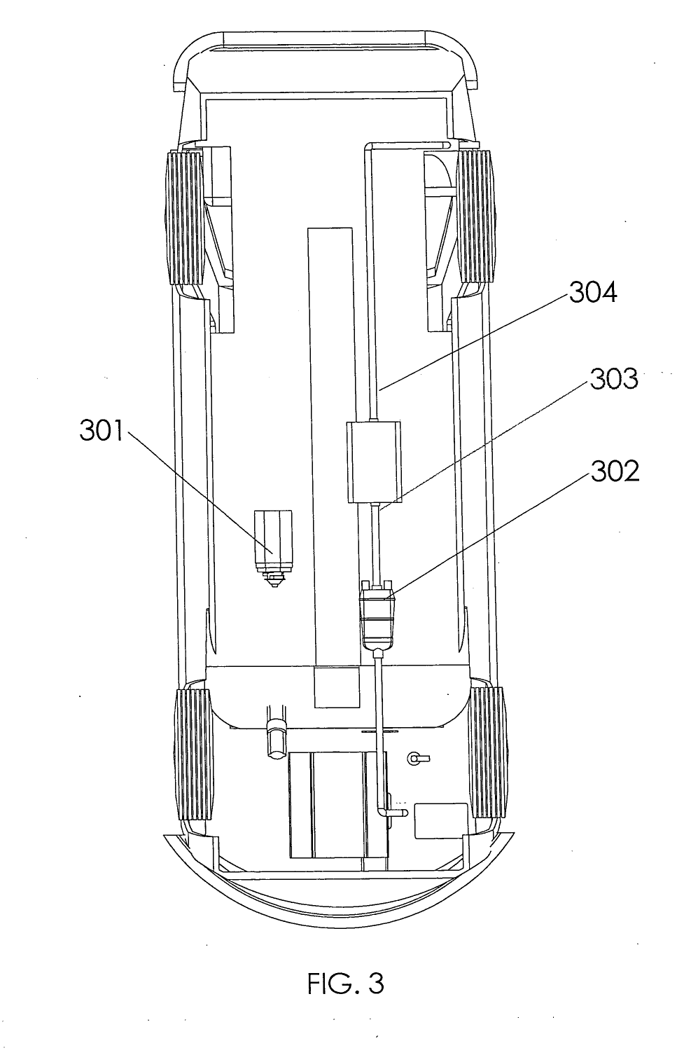

According to another embodiment of the present invention, aerogel materials can be used as part of a heat shield for the starter of a vehicle. For example, a starter 111 is shown on the undercarriage of a vehicle (see FIGS. 1B and 1C). An enlarged view of a starter 301 is shown in FIG. 3.

The starter is an important element responsible for the initial turns of the engine upon starting the vehicle. Typically, the starter is connected by a small gear to the engine, and thus is located very close to the engine. This close proximity to the engine, when combined with elevated engine temperatures, can decrease the operating life of the starter, leading to unexpected and premature failures. For this reason, starters conventionally have been protected by a metal heat shield, typically made of steel or aluminum. A problem with such conventional heat shields is that the heat shields merely reflect radiant heat, and have a finite capacity to reflect radiant heat. A more effective insulating heat shield would be desirable to ensure long-term performance of the starter.

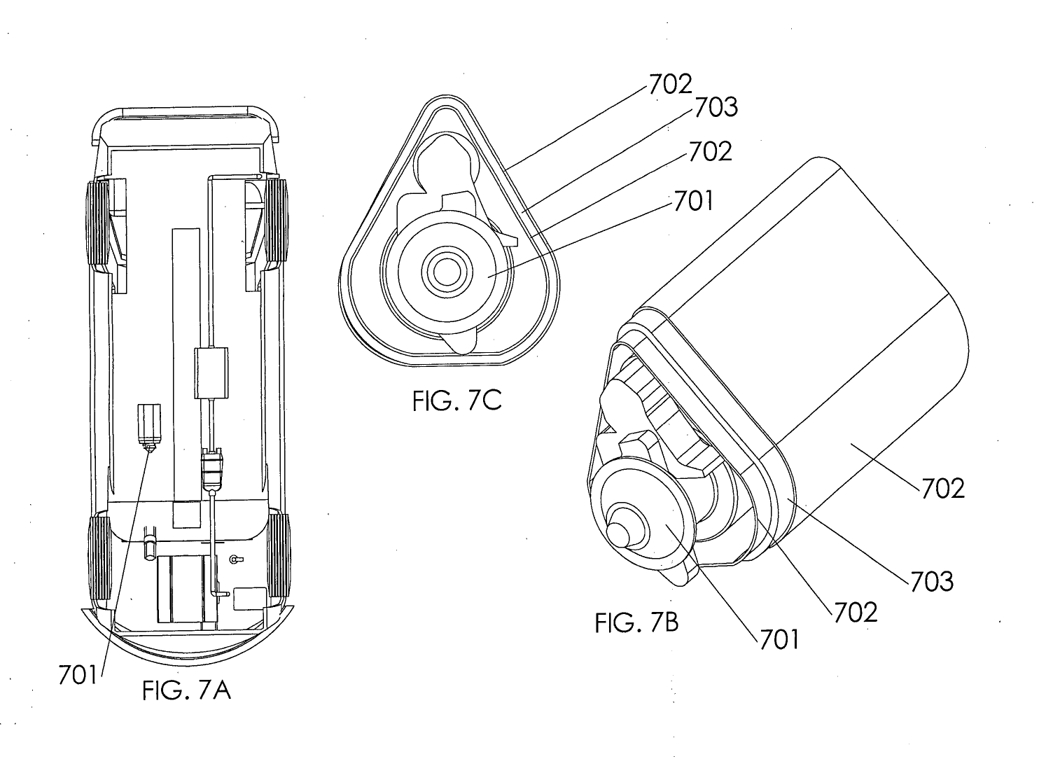

Referring to FIGS. 7A to 7C, a starter 701 is depicted on the undercarriage of a vehicle in FIG. 7A. The starter typically is located near the back or bottom of the engine, and close to the ground. As shown in FIGS. 7B and 7C, an aerogel material 703 preferably is encapsulated with a moderate to high temperature coating or film 702, such as urethane or silicone, to protect the aerogel material 703 from exposure to road debris and engine fluids. After encapsulation, the encapsulated aerogel material 702, 703 may be laminated to a pre-shaped piece of rust-inhibited steel or aluminum that follows the outline of the starter, and then affixed to the starter via a bolted mounting bracket or other suitable means (not shown). Following lamination, this assembly can be mounted to the starter, e.g., between the engine and the starter. Instead of providing a lamination, the aerogel material can be completely encapsulated by pre-formed steel or aluminum, thus eliminating the need for a protective coating.

According to yet another embodiment of the present invention, batteries can be protected from heat by using aerogel materials. Lead acid batteries produce their power from a wet electrolytic chemical reaction. Their ability to supply large amounts of power for a short period, hold a charge well, and not suffer from charge leak makes them an ideal battery for automotive applications. However, there are several drawbacks to conventional batteries such as: low charge density, safety issues, and sensitivity to temperature. The typical wet chemistry lead acid battery performs optimally at 70° F. As temperature decreases, the battery will produce less power, while as the temperature increases the batteries suffer increased storage power loss and potential loss of electrolyte which can permanently degrade performance.

Most automotive batteries are located in the engine compartment, as indicated by the battery 101 in FIG. 1A and the battery 201 shown in FIG. 2. By positioning the battery 201 under the hood, the battery is exposed to thermal soak created under the hood of the modern automobile. Under hood temperatures have risen over time because of design requirements to increase specific engine power and to increase passenger space. Therefore, automobile manufacturers have sought to protect batteries using different thermal management strategies based on thermal capacity, cost, and space requirements.

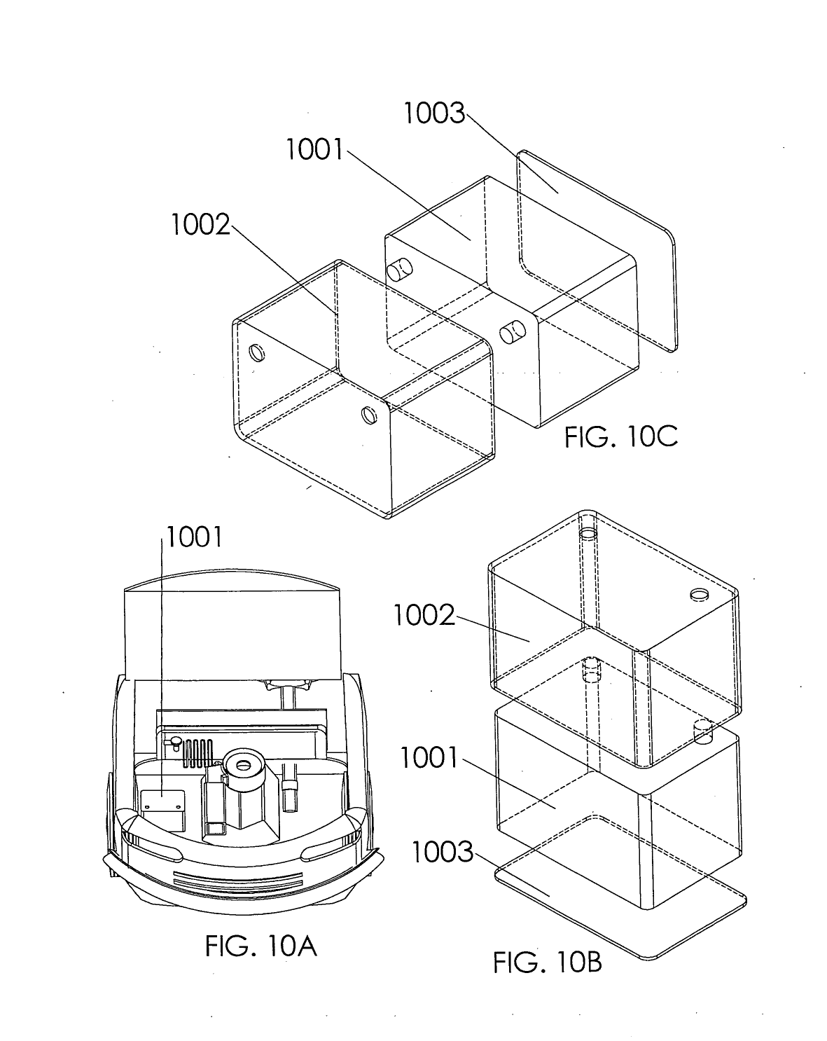

Aerogel materials can be used to protect batteries during episodes of high under hood temperature events, e.g., during stop-and-go traffic combined with high ambient temperatures. FIGS. 10A to 10C depict a vehicle battery incorporating an aerogel material. The aerogel material can be applied to the battery in several ways. For example, the aerogel material can be incorporated directly into the battery design itself by the battery manufacturer. Alternatively, as shown in FIGS. 10B and 10C, aerogel material insulation can surround the battery 1001, such that the battery is enclosed by an outer cover 1002 incorporating aerogel material, and an end of the battery 1001 is covered by an end cap 1003 incorporating aerogel material.

The aerogel material surrounding the battery can be encapsulated to protect it from the harsh under hood environment and for ease of installation and removal. The encapsulation can be flexible or rigid and can be manufactured from any material suitable for use in an under hood application. The battery outer cover 1002 and end cap 1003 may or may not have cut outs for the battery terminals and may or may not cover the entire battery. A similar system can be used to insulate the many different types, voltages and chemistry of batteries and other electric power storage devices now proliferating in fuel-electric hybrid drive vehicles, fuel cell vehicles, and hydrogen drive vehicles.

As light vehicle power trains continue to run hotter to deliver the acceleration and power demanded from smaller engines, the temperature of engine exhaust systems and components also has increased. Temperatures of 300-400° F. are not uncommon, and upwards of 700° F. or more in the area of the catalytic converter. If allowed to, these temperatures could be transferred in significant part through the floor pan and into the vehicle interior, but vehicle manufacturers conventionally have used materials such as cotton shoddy and non-woven polyesters as insulation between the interior carpeting and the vehicle's floor pan. Additionally, over especially hot areas of the exhaust system, a heat shield is typically installed. However, as temperatures have continued to climb into the ranges noted above, these approaches to insulating the vehicle interior from exhaust heat are not sufficient, or the thickness of the material used must be increased to the point where they take up too much space or add too much weight to the vehicle. Since aerogel materials typically have between two and six times more thermal resistivity than existing insulations, they represent an ideal way to insulate against these higher temperatures without giving up more interior space to insulation, or increasing the weight of the vehicle.

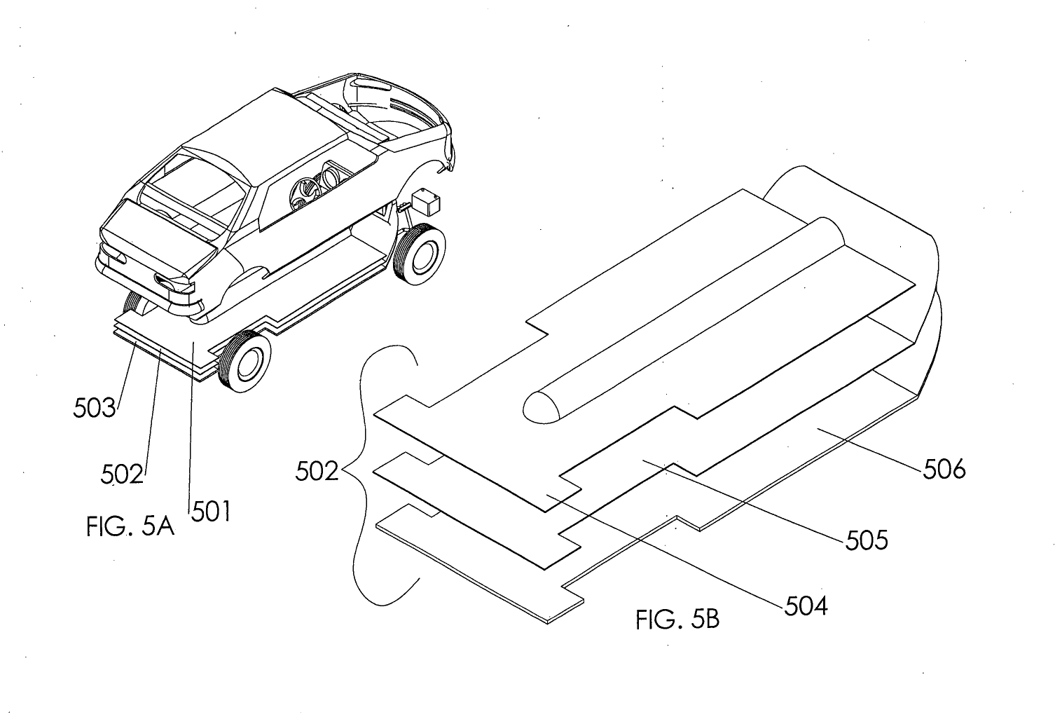

An embodiment of the present invention for insulating the floor of a vehicle is shown in FIGS. 5A and 5B. A floor insulation system 502 using aerogel materials can be installed between an interior carpet 501 and a floor pan 503 of the vehicle. The insulation system 502 includes an aerogel blanket 505, preferably made of a fiber-reinforced aerogel composite material, encapsulated between upper and lower layers 504 and 506, respectively, of a polymer film or fabric such as cotton. One or more additional layers of insulation or encapsulation can be added to the structure depicted in FIG. 5B. The arrangement shown in FIGS. 5A and 5B can reduce the amount of exhaust heat that might otherwise be transferred to the interior of the vehicle through the carpet 501.

According to another embodiment of the present invention, automobile tops including convertible tops can be insulated with aerogel materials. Referring to FIG. 1B, a convertible top 108 is principally attached to the vehicle at the windshield 107 and a storage area 109 for the convertible top. As the convertible top is not fully attached to the vehicle frame, it is essentially a removable top and must be constructed to handle being opened and closed many times. Generally, the convertible top 108 is a thin, flexible structure without the stiffness, reinforcement, and other properties of a conventional hard top. As such, the convertible top 108 provides less of a barrier to sound and temperature and external elements that can interfere with conversation, listening to the radio or otherwise lead to a less pleasant driving experience. These elements include, but are not limited to: road and wind noise, the sounds of other vehicles, traffic, noise from construction sites and so forth. In addition, sounds originating from the operation of the vehicle itself can be transmitted through the vehicle's structure to the top, and subsequently into the passenger cabin. Moreover, high temperatures transmitted through the convertible top can adversely affect operation of vehicle climatic control systems.

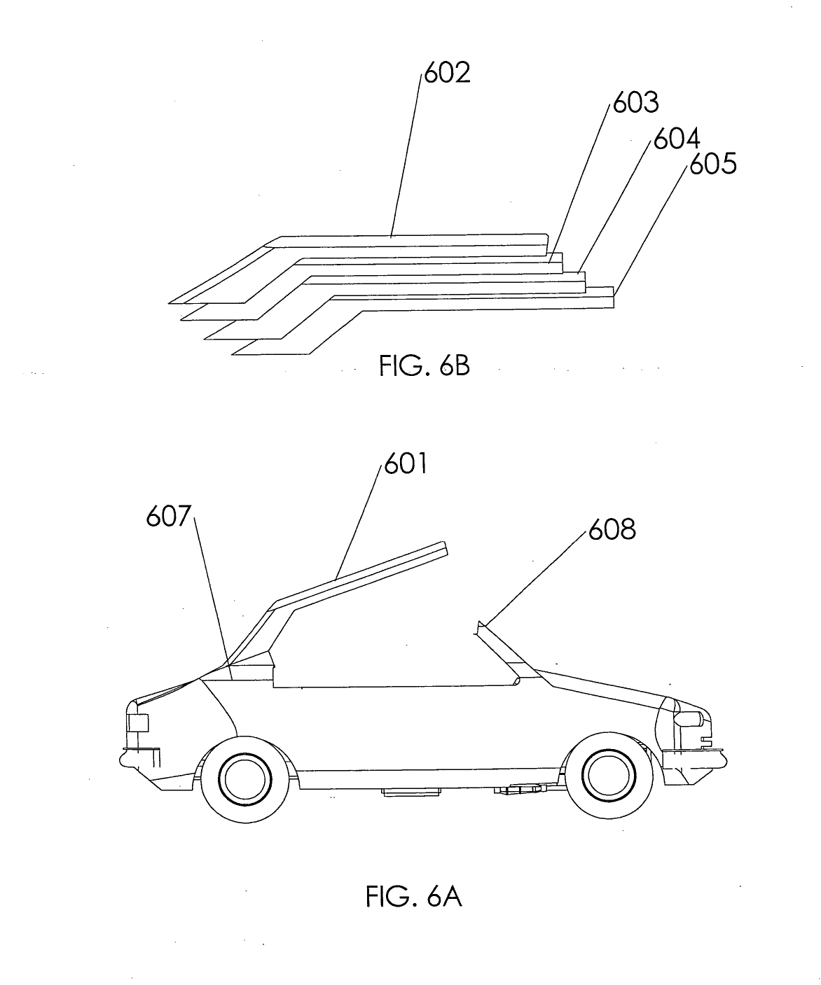

Referring to FIGS. 6A and 6B, by providing a convertible top 601 which incorporates aerogel material insulation 604, noise and temperature transmitted through the top and into the passenger compartment can be substantially reduced, or rendered inconsequential. As shown in FIG. 6B, a headliner 605 is utilized, and space between the headliner 605 and an outer layer 602 of the convertible top 601 is filled with insulation 604 incorporating aerogel materials. Preferably, the aerogel material insulation is concentrated on the passenger side of the convertible top 601. Such insulation can improve the acoustical and thermal performance of the convertible top, leading to a quieter and more comfortable passenger cabin when the top is in the closed position. Additionally, transparent aerogel materials can be used in windshields 608, and side and rear windows of the vehicle to provide thermal insulation.

In accordance with the embodiment depicted in FIGS. 6A and 6B, since the presentation of insulation material in plain view of the passenger compartment is undesirable, the headliner 605 made of fabric or other suitable material is used to cover or hide the passenger side of the top, which preferably incorporates the aerogel material.

The aerogel material insulation 604 can be installed in the space between the outer layer 602 and the headliner 605 in different ways and a variety of forms. Most simply, insulation is placed into this space with little or no attachment to the outer layer 602 or the headliner 605. Alternatively, the insulation 604 can be combined with the headliner 605, and then the combination is attached to the passenger side of the convertible top 601. A further alternative is to attach or otherwise incorporate the insulation 604 into the outer layer 602 or underside of the convertible top 601, and then affix the headliner 605 to the insulation 604.

The aerogel material insulation 604 used in the embodiment of FIGS. 6A and 6B can be formed as a loose aerogel blanket, which is simply stuffed between the headliner 605 and the outer layer 602 of the convertible top. As a further refinement of this approach, the aerogel material insulation 604 can be encapsulated or coated in one or more films or fabrics 603, such as small denier tightly woven cotton poly fabric, polymeric film, adhesive, or other materials to facilitate installation. The aerogel material can be simply placed in a loose fitting pillowcase of fabric, and then this assembly stuffed into the space between the headliner and convertible top. Alternatively, the fabric could be laminated to the aerogel material, and then this assembly placed into the available space.

The aerogel material insulation 604 could be laminated directly to the headliner 605, and then coated on the backside with an adhesive and release liner. When the headliner is installed, the aerogel material insulation would also be installed by peeling the release liner, and pressing the headliner and aerogel blanket assembly against the convertible top 601. A similar system could be employed by attaching the aerogel material insulation 604 to the outer layer 602, and then affixing the headliner 605 to the aerogel material insulation. Under this approach, the aerogel material insulation is laminated directly to the convertible top 601, and the other side of the aerogel material insulation is coated with an adhesive and release liner. Therefore, when the convertible top and aerogel material insulation are installed, the release liner is then pulled back and the headliner affixed to the aerogel material insulation.

While a variety of materials can be used for the aerogel material insulation 604, it is desirable to use a material that has a very high capacity for acoustical and/or thermal insulation per unit of thickness, since the insulation 604 must be installed in a limited space, and vehicle manufacturers generally dislike decreasing headroom and/or adding more mass to the vehicle. Additionally, by decreasing the size of the convertible top 601, the storage space 607 for the convertible top also can be reduced, and this previously unavailable space used to increase the size of the interior or trunk. Thin aerogel material insulations 604 are preferred, since they provide between about two to six times improved thermal performance and equivalent acoustical capacity at about 50-75% of the thickness of existing materials. The aerogel material insulation can be provided in the form of a fiber-reinforced aerogel composite, or alternatively as a monolith in powder, granular, and/or bead form.

According to a further embodiment of the present invention, aerogel materials can be used in the exhaust system. A typical exhaust system is depicted in FIG. 3, and includes a catalytic converter 302, muffler 303, and exhaust pipe 304 on the undercarriage of a vehicle (see also FIG. 1C, depicting a catalytic converter 110, muffler 112, and exhaust pipe 113).

The exhaust system removes the byproducts of combustion from the vehicle, cleans the effluent of unwanted pollutants, and reduces engine noise to an acceptable level. Most exhaust systems perform optimally at high temperatures; the exhaust manifold of a typical automobile can reach temperatures of 1500° F. This high temperature allows the catalytic converter to work efficiently but also unduly heats the undercarriage and then the interior of the vehicle. To counter this effect, designers have turned to heat shields to mitigate the negative thermal effects of the exhaust system. These heat shields can be multi-layer materials and for the most part act as barriers to thermal radiation and convective path interrupts.

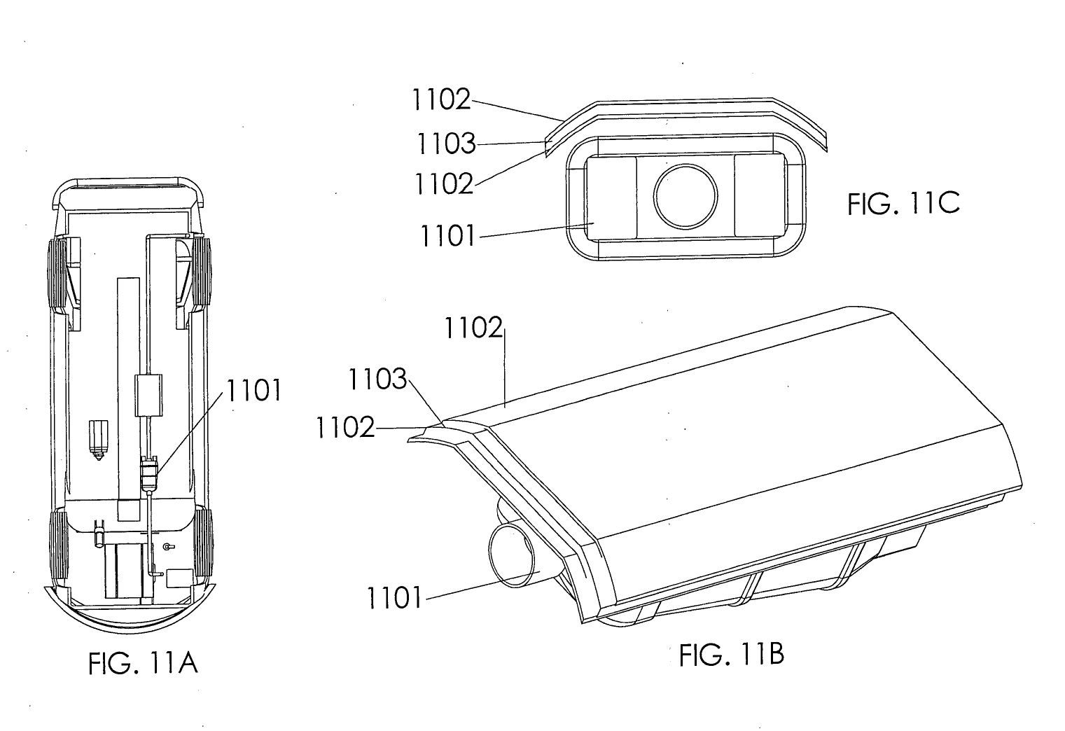

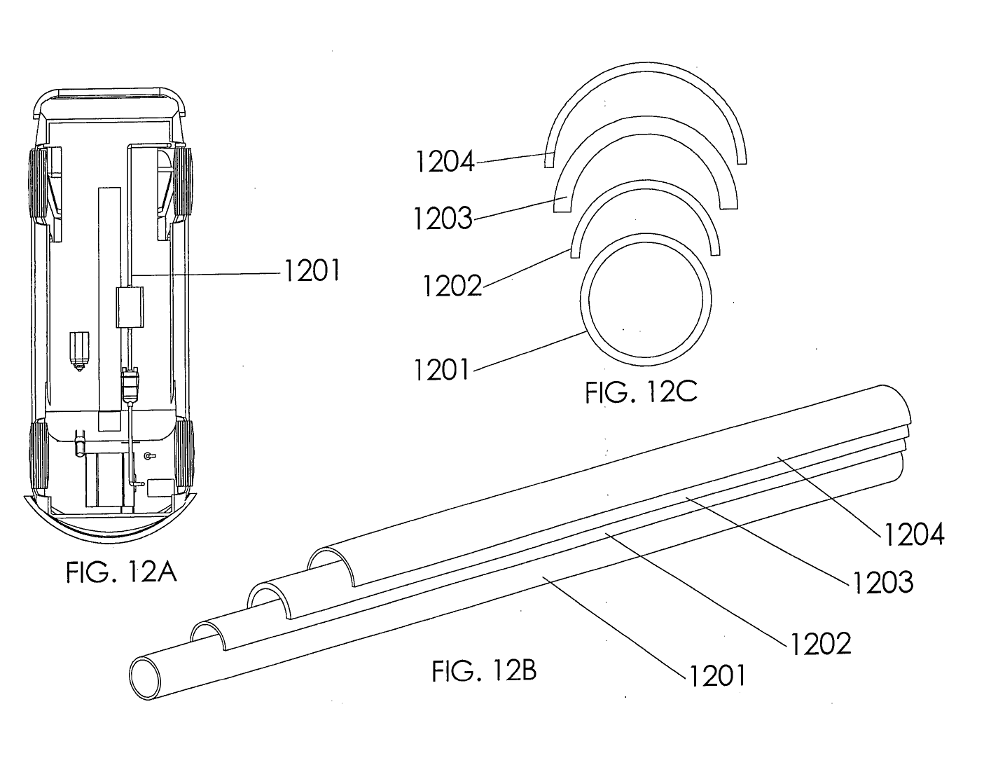

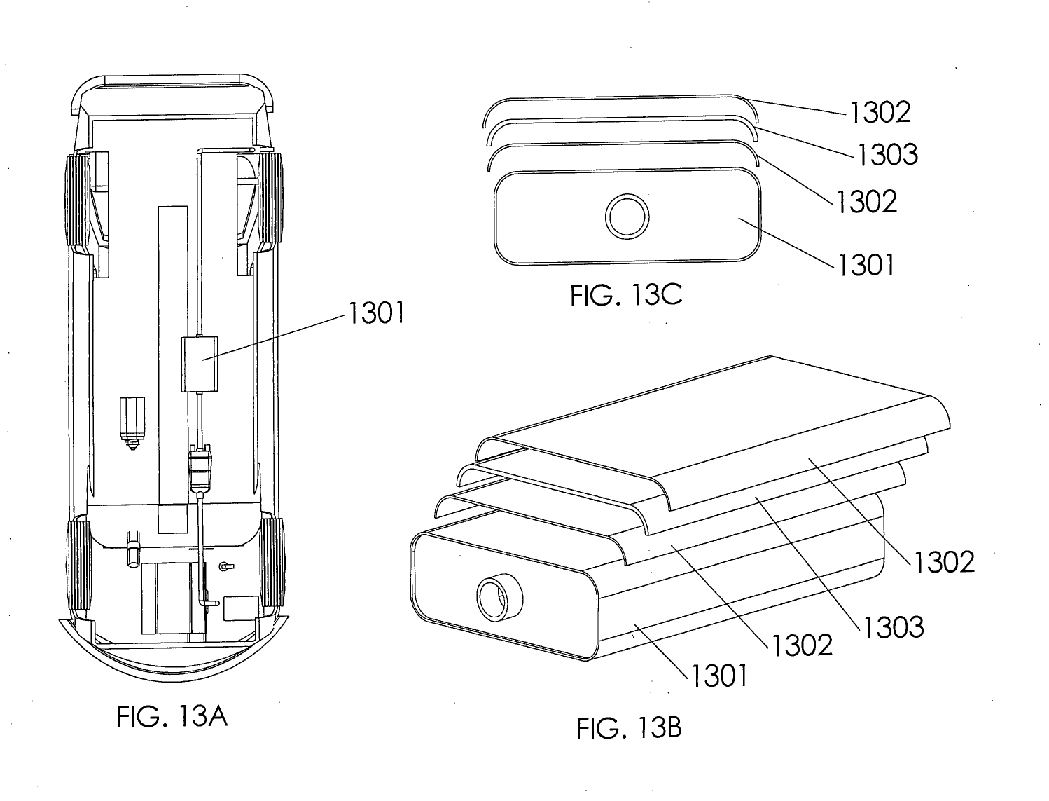

A heat shield having a core of material insulation generally is more effective than one made to simply reflect radiation. FIGS. 11A to 11C depict an exhaust system including a catalytic converter equipped with a heat shield according to the present invention. The heat shield preferably includes a flexible aerogel blanket 1103 sandwiched between at least upper and lower layers of an encapsulating material 1102. The encapsulating material may be a multi-layer composite, including a coating, film, and/or fabric to initially seal the aerogel materials from the environment, and then further encapsulated in a metal covering to act as a radiation reflector, or to add robustness to the combination for use under the chassis. The heat shield can have a rigid, semi-rigid, or flexible design. A heat shield incorporating aerogel materials preferably is attached in an appropriate location, such as over the catalytic converter 1101, the muffler 1301 (see FIGS. 13A to 13C), the exhaust pipe 1201 (see FIGS. 12A to 12C), or any portion of the exhaust deemed necessary including the exhaust manifold, and flow paths associated with turbochargers or exhaust gas recirculation. Attachment can be accomplished by a variety of methods, including welding, mechanically fastening, or chemical adhesion via all manner of adhesives.

Another example of a heat shield according to the present invention for use in the exhaust system of a vehicle includes the muffler 1301 shown in FIGS. 13A to 13C. A heat shield for the muffler 1301 preferably includes a flexible aerogel blanket 1303 sandwiched between at least upper and lower layers of an encapsulating material 1302. The encapsulating material may be a multi-layer composite, including a coating, film, and/or fabric to initially seal the aerogel materials from the environment, and can further include a radiation reflector, as described above. A further example of a heat shield for use in the exhaust system of a vehicle includes the exhaust pipe 1201 shown in FIGS. 12A to 12C. Similar to the muffler 1301, a heat shield for the exhaust pipe 1201 preferably includes a flexible aerogel blanket 1203 sandwiched between at least upper and lower layers of an encapsulating material 1202. Additional layers of encapsulating material may also be provided.

Alternatively, in the exhaust system, heat shielding may be incorporated directly into the design of individual components such as the catalytic converter 1101, muffler 1301, and exhaust pipe 1201 to achieve a desired cold side temperature, thereby reducing or eliminating the need for secondary heat shielding.

The use of aerogel materials in the exhaust system can provide performance benefits over conventional types of insulation. The aerogel materials can be incorporated into the design in a variety of ways, filling the annular space in between a double-walled exhaust pipe, or layering the material inside the outer wall of the component in question. The use of aerogel materials can allow for superior thermal performance while consuming a minimal amount of space. For the designer of automotive components this can translate into either smaller, lighter components compared to ones insulated with a less efficient insulation, or similar sized components with superior thermal performance.

According to another embodiment of the present invention, aerogel material insulation can be installed in the gap where the steering column passes through the firewall. Though relatively small, this gap is a breach in the generally sealed and insulated interior space of the passenger cabin. Because the gap is so small, it can benefit in particular from the use of a high capacity insulation material such as aerogel blankets. Aerogel blankets, e.g., in the form of fiber-reinforced aerogel composites, are about two to six times more effective than conventional insulation materials at insulating against heat and noise, so they can provide maximum effect in constrained spaces such as the steering column/firewall gap.

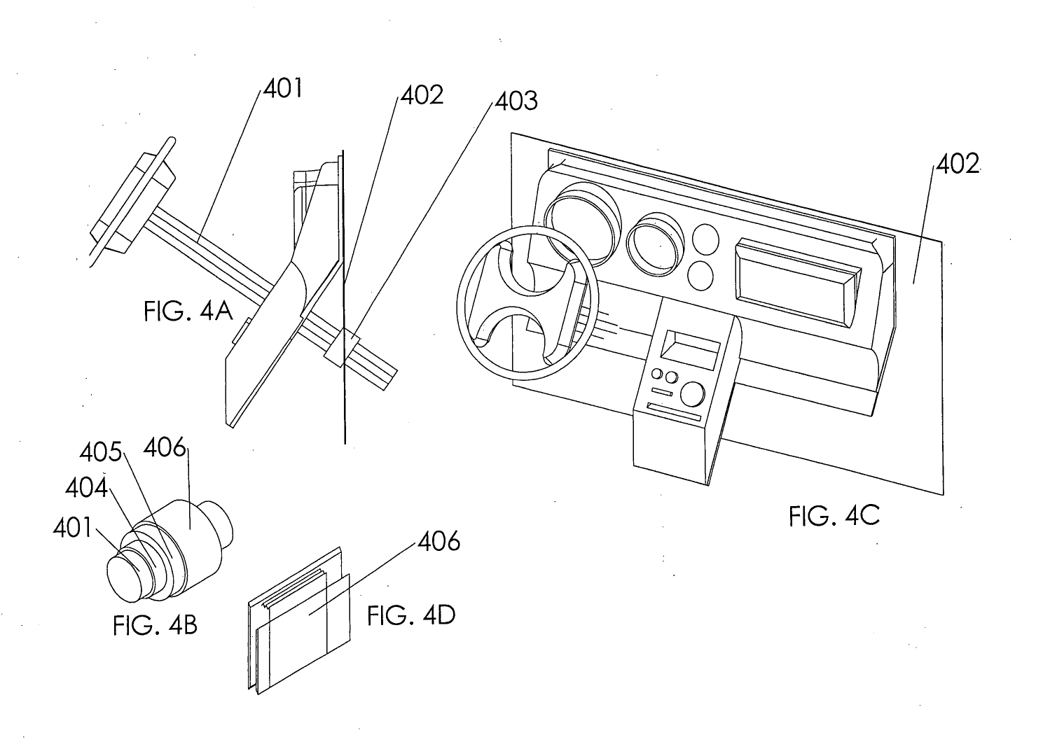

Referring to FIG. 1B, the steering column 106 passes from the engine compartment into the passenger cabin through the firewall 105. This passage creates a small gap that would otherwise allow engine heat and noise to enter the passenger cabin. Referring to FIGS. 4A to 4D, an aerogel material insulation system 403 includes an aerogel material blanket 405 sandwiched between an inner encapsulating layer 404 and an outer encapsulating layer 406. The inner and outer encapsulating layers preferably are made of an elastomeric film, the inner encapsulating layer contacting the steering column 401. The aerogel material insulation system 403 can insulate the gap between the steering column 401 and the firewall 402, thereby reducing the ability of heat and sound from the engine compartment to enter the passenger compartment.

Electronics packages in modern automobiles are becoming larger and more complex over time. The increasing size of the electronics package, the increase in engine temperature and the close physical proximity of the two systems can thermally stress many of the electronics package microprocessor-based systems. Insulation made from an aerogel material can be used to improve electronic component longevity by protecting it from the high temperature of the engine compartment. An aerogel material used in conjunction with electronics components preferably is encapsulated, where the encapsulating material may be a multi layer composite, including a coating, film, foil, fabric, or any suitable material to seal the aerogel material from the service environment. The aerogel material preferably is attached in some fashion to the back of the electronics package or passenger side of the firewall 105 (see FIG. 1A) with an appropriate fastening system, or it may be incorporated into the dash board design. A similar system could be used to insulate the entire firewall between the engine and passenger compartments. With the selection and placement of the proper grade of aerogel material the insulation can mitigate sound and heat, and further act as an enhanced fire barrier in case of a severe collision.

According to a further embodiment of the present invention, an aerogel material can be incorporated into both permanent and removable drink holders to protect items placed in the drink holders from undesirable thermal effects.

According to a further embodiment, a climate control device can be insulated with an aerogel material to provide optimal performance.

According to a further embodiment, the fuel tank of a vehicle can be insulated with an aerogel material. Since aerogel materials have demonstrated superior performance as high thermal load barriers (e.g., acetylene torch at 1400° C.) they are ideal for such application. An encapsulated and/or coated form of an aerogel material may be wrapped either entirely or partially around a fuel tank. Metal or plastic bands can then be used to secure the assembly.

The above-described approaches of using aerogel materials to protect light vehicle components from excessive heat also can be applied in a variety of other settings. For example, many similar components and systems are found under the hoods of heavy vehicles such as trucks, buses, and military land vehicles. Marine, aircraft and locomotive engines, as well as power turbines have components and fluids that must be protected from heat. For example, in an aircraft engine or power turbine, the lubricating oil must be protected from high temperatures, often in the range of about 500 to 800° F., generated by the engine or turbine.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various other changes in form and details may be made therein without departing from the scope of the invention.

### Inorporation By Reference

The entire contents of all patents, published patent applications and other references cited herein are hereby expressly incorporated herein in their entireties by reference.

What is claimed is:

1. A thermal management system, comprising:
at least one component of a vehicle; and
an aerogel material enclosed in an encapsulating material, the aerogel material and encapsulating material provided on or near the at least one component.

2. The thermal management system of claim 1, wherein the aerogel material is in granular form.

3. The thermal management system of claim 1, wherein the aerogel material is in monolithic form.

4. The thermal management system of claim 1, wherein the aerogel material is in fiber-reinforced composite form.

5. The thermal management system of claim 1, wherein an amount of opacifying compound is incorporated into the aerogel material.

6. The thermal management system of claim 5, wherein the opacifying compound is B4C, diatomite, manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

7. The thermal management system of claim 1, wherein the component is an air intake.

8. The thermal management system of claim 1, wherein the component is an expansion valve.

9. The thermal management system of claim 1, wherein the component is a starter.

10. The thermal management system of claim 1, wherein the component is a battery.

11. The thermal management system of claim 1, wherein the component is a floor.

12. The thermal management system of claim 1, wherein the component is a headliner.

13. The thermal management system of claim 1, wherein the component is a convertible top.

14. The thermal management system of claim 1, wherein the component is a catalytic converter.

15. The thermal management system of claim 1, wherein the component is a muffler.

16. The thermal management system of claim 1, wherein the component is an exhaust pipe.

17. The thermal management system of claim 1, wherein the component is a steering column.

18. The thermal management system of claim 1, wherein the component is a firewall.

19. The thermal management system of claim 1, wherein the component is an electronics package.

20. The thermal management system of claim 1, wherein the component is a drink holder, climate control device, fuel tank, or spark plug.

21. The thermal management system of claim 1, wherein the vehicle is an automobile.

22. The thermal management system of claim 1, wherein the encapsulating material comprises a polymer.

23. The thermal management system of claim 1, wherein the encapsulating material comprises an elastomer.

24. The thermal management system of claim 1, wherein the encapsulating material comprises a metal.

25. The thermal management system of claim 1, wherein the aerogel material is coated with a polymer.

26. The thermal management system of claim 1, wherein the aerogel material is coated with an elastomer.

27. The thermal management system of claim 1, wherein the aerogel material is coated with a metal.

28. The thermal management system of claim 1, wherein the aerogel material and the encapsulating material form a heat shield.

29. The thermal management system of claim 1, wherein the aerogel material is provided in a flexible or drapable form.

30. The thermal management system of claim 1, wherein the aerogel material has a thermal conductivity of less than about 20 mW/m*K.

31. The thermal management system of claim 1, wherein the aerogel material has a thermal conductivity of less than about 15 mW/m*K.

32. The thermal management system of claim 1, wherein the aerogel material is reinforced with a fibrous batting.

33. A thermal management system, comprising:
at least one component of a vehicle; and
an aerogel material in fiber-reinforced composite form, the aerogel material provided on or near the at least one component.

34. The thermal management system of claim 33, wherein the aerogel material is enclosed in an encapsulating material.

35. The thermal management system of claim 34, wherein the encapsulating material comprises a polymer.

36. The thermal management system of claim 34, wherein the encapsulating material comprises an elastomer.

37. The thermal management system of claim 34, wherein the encapsulating material comprises a metal.

38. The thermal management system of claim 33, wherein the aerogel material is coated with a polymer.

39. The thermal management system of claim 33, wherein the aerogel material is coated with an elastomer.

40. The thermal management system of claim 33, wherein the aerogel material is coated with a metal.

41. The thermal management system of claim 33, wherein the aerogel material forms a heat shield.

42. The thermal management system of claim 33, wherein the aerogel material is reinforced with a fibrous batting.

43. The thermal management system of claim 33, wherein the vehicle is an automobile.

44. A method for insulating at least one component of a vehicle, comprising the steps of:
providing the at least one component;
providing an aerogel material in fiber-reinforced composite form; and
attaching the aerogel material on or near the at least one component.

45. The method of claim 44, further comprising a step of enclosing the aerogel material in an encapsulating material.

46. The method of claim 45, wherein the encapsulating material comprises at least one of a polymer, an elastomer, or a metal.

47. The method of claim 44, further comprising a step of coating the aerogel material with at least one of a polymer, an elastomer, or a metal.

48. The method of claim 44, further comprising a step of incorporating an amount of opacifying compound into the aerogel material.

49. The method of claim 48, wherein the opacifying compound is B4C, diatomite, manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (iE) oxide, manganese dioxide, iron titanium oxide (ilmenite), chromium oxide, silicon carbide or mixtures thereof.
